(19) United States
(12) Patent Application Publication
(10) Pub. No.: US 2013/0138143 A1
(43) Pub. Date: May 30, 2013

(54) ACUPRESSURE DEVICE WITH A PLURALITY OF INDIVIDUALLY-CONTROLLED APPLICATORS HAVING PROTRUSIONS EXTENDING THEREFROM

(71) Applicant: Gennady Chechelnitsky, Woodland Hills, CA (US)

(72) Inventor: Gennady Chechelnitsky, Woodland Hills, CA (US)

(21) Appl. No.: 13/304,637

(22) Filed: Nov. 26, 2011

(51) Int. Cl. A61H 39/04

(52) U.S. Cl. 606/204

(57) ABSTRACT

A variable pressure acupressure device of the invention includes a plurality of spaced apart applicators arranged on a belt for positioning over the required sensitive areas on the body. Patient-specific configuration and size of the device may be adjusted by selecting a number of applicators as well as their locations to match the desired locations for a patient, including linear, non-linear and two-dimensional configurations. Each applicator may be activated individually from a central controller in accordance with a predetermined acupressure sequence. The degree of skin compression may be also adjusted by selecting how far the protrusions are extending away from the base of the applicator. In embodiments, air pressure may be used for extending spring-loaded protrusions from individual applicators. An inflatable outer bag may be used to uniformly press all applicators against the curved portions of the body with the same force.

### BACKGROUND OF THE INVENTION

The present invention relates generally to the field of acupressure. More particularly, the invention describes a pneumatically-driven variable pressure automatic acupressure device in which the degree of extension of acupressure protrusions from at least some of its plurality of applicators may be individually controlled.

Stimulation of various areas on the body is known to be an effective treatment method for various conditions and ailments that affect the body. These areas lie along certain channels or meridians according to the practice of acupuncture and are typically of small size, often referred to as acupuncture points on the body. Treatment typically consists of stimulation of at least one or more frequently a certain combination of these areas in a single therapeutic session. The combination and sequence of stimulation has been determined through thousands of years of acupuncture experimentation.

Stimulation can be done invasively using small needles that are manipulated once inserted into an acupuncture area (acupuncture), by applying electrical pulses to the invasive needles (electroacupuncture), or by applying a heated element to the invasive needles (moxibustion). For example, Bertolucci, Nausea Control Device, U.S. Pat. No. 4,981,146 describes a nausea control device in the form of a watch-like housing attachable to the human wrist by an adjustable attachment band. The device uses non-invasive nerve stimulation whereby electricity is passed through two electrodes to stimulate nerves located on the ventral side of the wrist (this anatomical position is sometimes referred to as the palmar side of the wrist). The treatment provided by the device is sometimes referred to as electro-acupuncture, which is a form of acupuncture. The ventral site of application is referred to in the acupuncture art as the P6 point, pericardium 6 point, or master point of the pericardium meridian (sometimes referred to as the vascular meridian).

Another method is to use noninvasive, localized pressure applied to the acupuncture area using a fingertip or a small, hard, typically rounded instrument (acupressure). Portable devices for acupressure stimulation of an acupuncture area have been proposed and some are available for use by the lay person. For example, the Sea-Band (Sea-Band UK Ltd., USA) acupressure device is used for treating nausea due to motion sickness and is comprised of an elastic band with an incorporated hard, plastic nodule that is placed over the P6 area. Similar devices with elastic or inelastic bands have been proposed for treating nausea and vomiting by stimulating acupuncture areas on the wrist, e.g., Giarratano, U.S. Pat. No. 5,078,728, Humphrey, U.S. Pat. No. D356,433, Bruckner et al., U.S. Pat. No. 5,695,520, Griffith, U.S. Pat. No. D274,557, Ferber, U.S. Pat. No. 5,709,647. Yoo (U.S. Pat. No. 5,774,424) describes an acupressure stimulator consisting of a pressure plate with nodules. The plate is attached to the back of a watch for stimulating the wrist area.

The acupressure methods described above deliver a constant level of pressure to the acupuncture site to be stimulated. The scientific literature indicates that this type of constant acupressure can be effective, but that the effect is not consistent and typically wanes over time. This is because of the well-known nerve response referred to as nerve accommodation, wherein the nerve accommodates to a constant stimulus and essentially ignores it. The action potentials necessary to achieve the stimulation effect are then no longer produced. Thus, the user may receive short-term benefit that wanes with time causing the undesirable symptoms to reappear.

Attempts have been made to circumvent this defect in constant pressure acupressure devices. Jacobs (U.S. Pat. No. 4,574,787) describes a liquid filled device wherein the fluid is caused to vibrate, the vibration causing a changing pressure. A separate vibration source is necessary and the liquid may leak. Strumor (U.S. Pat. No. 5,607,749) describes a similar system in which air is used as the fluid and movement causes differential pressure leading to air flow into certain protuberances causing them to exert variable pressure; movement is necessary to achieve the changing pressure so the user cannot be stationary. Fisher (U.S. Pat. No. 5,601,598) describes a method in which the user is required to periodically stretch a band to cause changing pressure. This requires the user to stop any activity to stretch the band. While these methods have some functionality, they suffer from needing bulky equipment or active user participation that severely limits their utility.

Typical acupressure patients require extended periods of treatment in which the stimulation occurs over a number of areas on the body, making the current devices inconvenient and unworkable because they require constant operator action or immobility. For patients desiring extended treatment to be applied during normal activities and during rest, without operator attention, the devices described below are desired.

### SUMMARY OF THE INVENTION

Accordingly, it is an object of the present invention to overcome these and other drawbacks of the prior art by providing a novel acupressure device having a plurality of applicators to allow simultaneous stimulation of more than one sensitive area on the body.

It is another object of the present invention to provide an acupressure device in which individual applicators may be individually-controlled.

It is a further object of the present invention to provide a variable pressure acupressure device in which the degree of protrusion extension from an individual applicator may be individually controlled to include at least a retracted state, a partially extended state and a fully extended state.

It is yet a further object of the present invention to provide an acupressure device in which all applicators are pressed against the body with substantially the same initial force—regardless of the body profile and curvatures.

The variable pressure acupressure device of the invention includes a plurality of spaced apart applicators arranged on a belt or otherwise operably positioned and retained against the desired sensitive areas on the body. Configuration and size of the acupressure device may be adjusted by selecting a number and individual positions of each applicator to match the desired locations for an individual patient, including non-linear and two-dimensional configurations. Each applicator may be activated individually from a central controller in accordance with a predetermined acupressure sequence. The degree of skin compression may be adjusted by selecting how far the protrusions are extending away from the base of each applicator. In embodiments, air pressure may be used to cause spring-loaded protrusions to extend from each or at least some of individual applicators. In other embodiments, an inflatable outer bag may be used to assure that all applicators are pressed against the curved body with the same force.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a schematic side view of a first embodiment of the acupressure device of the invention;

FIG. 2 is a schematic side view of a second embodiment of the acupressure device of the present invention;

FIG. 2a is a top view of the hexagon-like assembly of the applicators representing an example of a two-dimensional arrangement of the device according to the second embodiment of the invention (shown with an inflatable outer bag removed for clarity of illustration);

FIG. 3 is a side view of a single applicator;

FIG. 4 is a cross-sectional view of the same;

FIG. 5 is an exploded side view of the same;

FIG. 6 is a side view of an elastic connector for attaching one applicator to the next; and

FIGS. 7a through 7d show various states of extension of the protrusions from an applicator.

### DETAILED DESCRIPTION OF THE PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present invention provides a number of individual applicators that can be arranged in a patient-specific manner so as to apply variable pressure to a desired number of areas and over a desired period of time. To achieve this, each applicator may be individually activated from a central controller as described in more detail below.

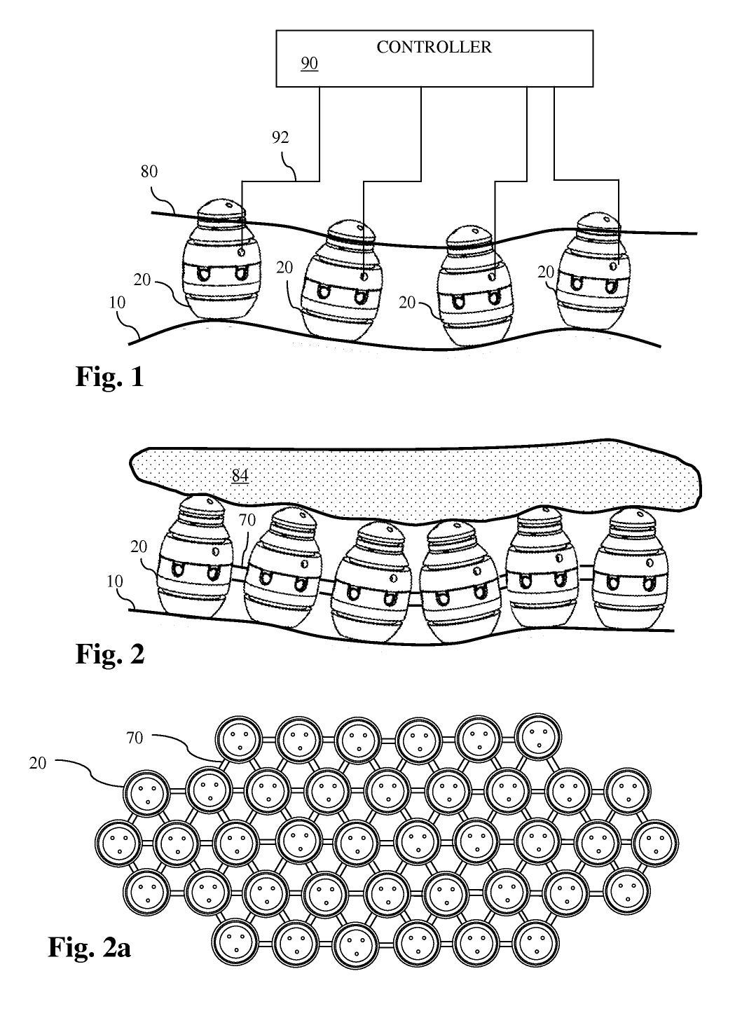

FIG. 1 depicts a general schematic side view of the first embodiment of the present invention. A desired number of individual applicators 20 may be operably arranged and retained over a patient skin 10 to be in touch with areas of the skin sensitive to acupressure therapy. To retain the plurality of individual applicators 20 in place, a belt 80 may be provided. As will be explained in greater detail below, each applicator 20 may be configured to be attached to the belt 80 in any desired location. Once these desired locations are mapped on the belt 80, assembly of the device may proceed to achieve the desired configuration as shown. The ends of the belt may be wrapped about the remaining portion of the body and connected together to provide necessary tightness of positioning of applicators 20 over the skin 10 (not shown). Elastic and non-elastic belts may be used for this purpose. In embodiments, the belt 80 may be made from a rubber, leather or fabric sheet.

As explained in greater detail below, at least some of the applicator 20 may be energized (or activated) and individually controlled to cause its protrusions to extend therefrom and press against the skin to achieve acupressure stimulation. Electric, pneumatic, hydraulic or mechanical energizing of applicators may be used for this purpose. In embodiments, pneumatic activation of individual applicators may be applied by a central controller 90 via individual conduits 92 connecting applicators 20 to the controller 90.

In embodiments, the controller 90 may include a source of compressed air such as an electrically activated compressor or a compressed air cylinder; a series of valves and pressure regulators configured to individually control one or a series of applicators 20; a central processing unit containing a desired programmed sequence of operations and optionally a display and control buttons. Each valve and pressure regulator may be configured to supply compressed air at various desired pressure levels via its respective conduits 92 to one or more applicators 20. Note that one conduit 92 may be connected to one or more applicators 20 in which case all applicators 20 connected to a single conduit 92 will be controlled in a parallel manner.

FIG. 2 shows a side view and FIG. 2a shows a top view of the second embodiment of the invention in which individual applicators 20 are assembled together to be located side-by-side. Elastic connectors 70 (FIG. 6) may be used for that purpose. Each applicator 20 may have a number of receptacle openings 72 each such opening is configured to retain one end of the connector 70. More than one opening 72 may be provided for each applicator 20. In embodiments, these openings 72 may be radially spaced apart to provide for an opportunity to assemble applicators 20 together in a non-linear manner. For example, as shown in FIG. 2a, 6 openings 72 may be provided on each applicator 20 allowing a possibility of assembling hexagon-like arrangement of applicators 20. Resilient nature of the connector 70 allows individual applicators 20 to be positioned at somewhat variable degrees to the curvature of the skin and therefore provide appropriately uniform compression by extending protrusions. Other two-dimensional and non-linear assembly configurations of applicators 20 are also contemplated as the invention is not limited in this regard.

To assure uniform force with which the applicators 20 compress the skin 10 in cases of body curvature, the applicators 20 may be pressed against the skin by an inflatable outer bag 84 (removed from the illustration in FIG. 2a) which in turn may be retained against the patient by using temporary adhesive strips, another belt 80 or by tying the ends of the bag together and positioning the bag around the patient (not shown). Another advantage of pressing the applicators 20 against the skin using an inflatable outer bag 84 is that regulating of the air pressure inside the bag allows to easily adjust the compression force of the applicators against the skin.

A controller 90 may also be provided in a manner similar to that described for the first embodiment of the invention (not shown).

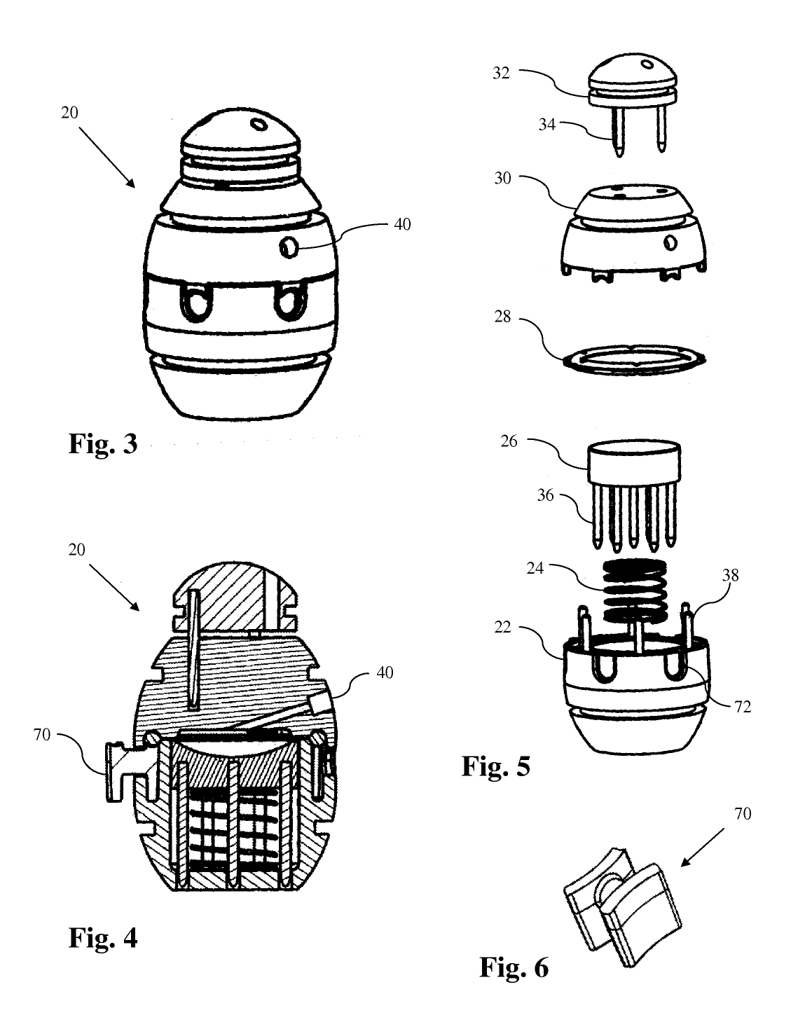

The individual applicator 20 will now be described in greater detail—see FIG. 3 through FIG. 6. The applicator 20 is designed to apply various degrees of skin pressure using one or more protrusions 36. Individual protrusions 36 are made from a rigid material such as a polymer or metal and have a pointed end exposed on the skin side of the applicator. The sharpness of the pointed end of each protrusion 36 is selected to be effective for acupressure but to not penetrate a skin layer as a needle when the protrusions are maximally extended from the lower base of the applicator 20.

Individual protrusions 36 are assembled on a piston 26, which in turn is retained between the upper base 30 and the lower base 22 of the applicator 20. A return spring 24 and an air sealing ring 28 are also located between the upper and lower base of the applicator 20. When assembled together, both the upper base 30 and the lower base 22 may be attached to each other by a threaded, snap-fit, or other appropriate connection, optionally using guiding pins 38.

The upper base 30 of the applicator 20 also contains an air channel 40 for attaching the air conduit 92 to the applicator 20.

The upper base 30 is further configured to provide for attachment of the applicator 20 to the belt 80. In embodiments, a belt retainer 32 equipped with one or more piercing pins 34 is provided to allow retention of the belt 80 between the upper base 30 and the belt retainer 32 along any desired location on the belt—see FIG. 1.

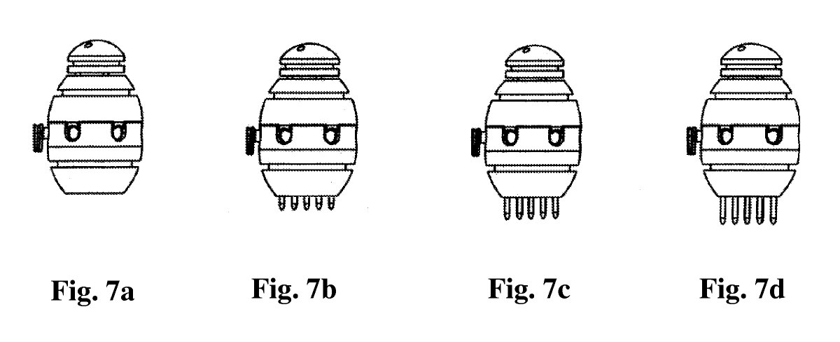

Applying compressed air through channel 40 causes the piston 26 to move against the return spring 24 whereby extending the protrusions 36 outwards. Depending on the pressure level, the protrusions may extend from a retracted state (FIG. 7a) to at least one partially extended state (FIGS. 7b and 7c) and then to a fully extended state (FIG. 7d) when the spring 24 is fully compressed. Removing pressure from the channel 40 causes the piston 26 to move in the opposite direction so as to retract the protrusions 36 back inside the applicator 20.

In embodiments, the controller 90 may be programmed or otherwise configured to cause periodic skin compression by activating one applicator 20 at a time or it can cause all applicators to be activated at the same time. Various other activation schemes are also considered to be a part of the present invention including matching protrusion activation to a rhythm of an audio recording signal such as music which is made available to the patient to listen to throughout the therapy session.

The herein described subject matter sometimes illustrates different components or elements contained within, or connected with, different other components or elements. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Although the invention herein has been described with respect to particular embodiments, it is understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A variable pressure automatic acupressure device comprising:
a plurality of spaced apart individual applicators operably retained against a skin of a patient, each applicator including at least one protrusion configured to extend therefrom to apply pressure to the skin of the patient upon activation of said applicator, and
a controller operably connected to said applicators and configured to activate at least some of said applicators individually according to a predetermined acupressure sequence.

2. The acupressure device as in claim 1, wherein said applicators include a spring-loaded piston attached to a plurality of protrusions, said controller is further configured to individually supply compressed air to said applicators to cause said protrusions to extend from said applicators according to said predetermined acupressure sequence.

3. The acupressure device as in claim 2, wherein said controller is further configured to cause partial or full extension of said protrusions from said applicators depending on a pressure of said compressed air supplied to said applicators.

4. The acupressure device as in claim 1, wherein said individual applicators are attached to a belt, said belt configured to position and retain said applicators against desired areas of the skin when wrapped about said patient.

5. The acupressure device as in claim 4, wherein each of said individual applicators includes a belt retainer with at least one piercing pin configured to penetrate said belt so as to retain said applicator on said belt at a desired location.

6. The acupressure device as in claim 1, wherein said individual applicators are attached to each other forming a linear, a non-linear or a two-dimensional assembly.

7. The acupressure device as in claim 6, wherein said applicators include at least one opening configured to accept an elastic connector therein, said applicators are attached to each other via said elastic connectors.

8. The acupressure device as in claim 7, wherein each applicator includes six openings radially spaced apart thereon for accepting up to six of said elastic connectors, said device formed as a hexagon-like two-dimensional assembly.

9. The acupressure device as in claim 1 further including an inflatable outer bag positioned over said individual applicators, wherein inflation of said outer bag assures uniform pressing of said applicators against the skin regardless of skin curvature.

10. The acupressure device as in claim 1, wherein said predetermined acupressure sequence is selected to match a rhythm of an audio recording while providing such recording to the patient during acupressure therapy.
